(19) United States
(12) Patent Application Publication
(10) Pub. No.: US 2024/0201221 A1
(43) Pub. Date: Jun. 20, 2024

(54) METHOD FOR ESTIMATING A LONGITUDINAL ACCELERATION OF AT LEAST ONE RAILWAY VEHICLE

(71) Applicant: FAIVELEY TRANSPORT ITALIA S.P.A., Piossasco, Torino (IT)

(72) Inventor: Matteo Frea, Cantalupa, Torino (IT)

(21) Appl. No.: 17/905,597

(22) PCT Filed: Mar. 17, 2021
(86) PCT No.: PCT/IB2021/052211

§ 371 Date: Sep. 2, 2022

(30) Foreign Application Priority Data
Mar. 17, 2020 (IT) 102020000005671

(51) Int. Cl. G01P 21/00; B61L 25/02; G01P 15/18

(52) U.S. Cl. CPC G01P 21/00; B61L 25/021; G01P 15/18

(57) ABSTRACT

A method for estimating a longitudinal acceleration of at least one railway vehicle by means of an accelerometric sensor means is described, comprising the steps of:
executing a calibration phase including the steps of:
   solving the following system, in order to determine the values of the first direction cosine k1, the second direction cosine k2 and the third direction cosine k3:

$$\{ \begin{matrix}{k}_{1} * {a}_{x} ( {t}_{c 1} ) + {k}_{2} * {a}_{y} ( {t}_{c 1} ) + {k}_{3} * {a}_{z} ( {t}_{c 1} ) = {a}_{ref} ( {t}_{c 1} ) \\ {k}_{1} * {a}_{x} ( {t}_{c 2} ) + {k}_{2} * {a}_{y} ( {t}_{c 2} ) + {k}_{3} * {a}_{z} ( {t}_{c 2} ) = {a}_{ref} ( {t}_{c 2} ) \\ {k}_{1} * {a}_{x} ( {t}_{c 3} ) + {k}_{2} * {a}_{y} ( {t}_{c 3} ) + {k}_{3} * {a}_{z} ( {t}_{c 3} ) = {a}_{ref} ( {t}_{c 3} )\end{matrix}$$

following the calibration phase, determining an estimated longitudinal acceleration value a₁ₒₙ(tᵢ₁) by means of the sum of a multiplication of the first direction cosine k₁ with a first acceleration aₓ(tᵢ₁), a multiplication of the second direction cosine k2 with the second acceleration a_{y}(tᵢ₁) and a multiplication of the third direction cosine k3 with the third acceleration a_{z}(tᵢ₁).

### CROSS REFERENCE TO RELATED APPLICATIONS

The present application is a U.S. National Phase of International Application No. PCT/IB2021/052211 entitled “METHOD FOR ESTIMATING A LONGITUDINAL ACCELERATION OF AT LEAST ONE RAILWAY VEHICLE,” and filed on Mar. 17, 2021. International Application No. PCT/IB2021/052211 claims priority to Italian Patent Application No. 102020000005671 filed on Mar. 17, 2020. The entire contents of each of the above-listed applications are hereby incorporated by reference for all purposes.

### TECHNICAL FIELD

This invention generally lies within the railway vehicle sector; in particular, this invention relates to a method for estimating a longitudinal acceleration of at least one railway vehicle.

### PRIOR ART

Slippage (also known as slip, slide or sliding) is understood to be a condition where there is a difference between the rotational speed of the axle and the speed of travel of the vehicle. This difference is defined as the slippage speed.

The slippage speed may be calculated using the following formula:

V_{sliding}=V_{R}−ωₐₓₗₑ*R (1)

where V_{RV} is the longitudinal speed of travel of the railway vehicle, ωₐₓₗₑ is the angular speed of the axle, and R is the radius of the wheel.

More modern railway vehicles have electronic systems installed on board that generally include subsystems for controlling the slippage of the wheels, which subsystems are adapted to intervene when the vehicle is in a traction phase or when the vehicle is in a braking phase. Subsystems of this kind are known as anti-skid or anti-slide systems or are also known as WSP (wheel slide protection) systems.

A system for controlling the adhesion of the wheels in an anti-slippage function according to the prior art is shown schematically in FIG. 1, which refers to a vehicle comprising n controlled axles A1, A2, . . . , An. The axles A1, A2, . . . , An comprise a relative shaft S1, S2, . . . , Sn and a relative pair of wheels W1, W2, . . . , Wn rotationally integral therewith.

In the drawings, only one wheel of each axle is generally shown.

The WSP system in FIG. 1 comprises an electronic control unit ECU, typically based on a microprocessor architecture, which receives tachometric signals relating to the angular speed of each axle A1, A2, . . . , An from sensors SS1, SS2, . . . , SSn respectively associated with these axles. The electronic unit ECU is also connected to torque control devices TC1, TC2, . . . , TCn which are each associated with a relevant axle A1, A2, . . . , An.

The electronic unit ECU is arranged to modulate the torque applied to each axle according to a predetermined algorithm if, when torque is applied during a traction or braking phase in situations of degraded adhesion, the wheels of one or more axles result in a condition of possible incipient slippage. The torque is modulated in such a way as to prevent the axles from jamming completely, possibly in such a way as to bring each axle into a controlled sliding situation, with a view to recover adhesion and in any case for the entire duration of the situation of degraded adhesion.

It is evident that knowledge of the instantaneous speed of the vehicle V_{RV}(t) is fundamental for correctly controlling the slippage.

One known method for accurately tracking the speed of a railway vehicle requires the maintenance of an idle axle, i.e. an axle which is not subjected to traction or braking torques. This is required to ensure that the measurement of its speed is the best reproduction of the real speed Vᵣₑₐₗ of said railway vehicle. This solution is particularly effective in the case of particularly low adhesion between the wheels and the track. In this case, in the event of traction or braking, all of said wheels could enter a slippage condition and would therefore not be able to provide correct information regarding the real speed of the vehicle. An idle axle which is not subjected to traction or braking torques could continue to accurately track the speed of the vehicle.

Modern railway vehicle architectures, particularly for underground railways, tend to have very limited compositions, for example are made of two carriages. In this case, the use of an “idle” axle would lead to a significant loss of traction and braking capacity of the train.

FIG. 2.a shows an example composition comprising two independent cars while FIG. 2.b shows an example composition comprising two cars constrained by means of a Jacobs bogie.

It is evident that the use of an idle axle disadvantageously reduces the traction and braking capacity by 12.5% in the first case and by so much as 16.7% in the second case.

In the prior art, there are also systems based on accelerometric sensors for measuring the forward speed of a vehicle.

Given the increasing availability and the progressive reduction in cost of MEMS (“micro electro-mechanical systems”), more and more electronic devices, regardless of their main application, integrate an accelerometric sensor, typically a triaxial accelerometric sensor, on board.

The use of an accelerometric sensor for estimating the longitudinal acceleration of the vehicle is, in principle, easily applicable.

Longitudinal acceleration is understood to mean the acceleration of the vehicle in its direction of travel. By integrating this longitudinal acceleration over time, the longitudinal speed, i.e. the speed of travel of the vehicle, is obtained. This methodology is clearly not affected by the above-described slippage problems to which the axles may be subjected in the event of degraded adhesion.

With reference to FIG. 3, a railway vehicle 1 is travelling on a track 3 and provided with an accelerometric sensor 2.

In the terrestrial/gravitational reference system, axis z may be defined as the direction of gravitational acceleration and axes x and y may be defined as the transverse directions on the plane perpendicular to z.

In the reference system integral with the vehicle, however, axis y′ may be defined as the longitudinal direction of the vehicle, axis x′ may be defined as the transverse direction of the vehicle and axis z′ may be defined as the direction perpendicular to the plane (“floor”) of the vehicle.

Furthermore, x″, y″ and z″ may be defined as the sensitive axes of the triaxial accelerometric sensor.

Now considering the ideal case in which the sensor is installed integrally with the vehicle, with the axes perfectly aligned with those of the vehicle, this will result in:

x′≡x″

y′≡y″

z′≡z″

Also considering the particular case in which the vehicle 1 is travelling on a section of track 3 that is perfectly straight and has no gradient, this will result in:

x′≡x″≡x

y′≡y″≡y

z′≡z″≡z

In these ideal conditions, the longitudinal acceleration of the vehicle may be directly deduced from the accelerometer measurements being:

aₜᵣₐᵢₙ=a_{y} (2)
where aₜᵣₐᵢₙ is the longitudinal acceleration of the vehicle and a_{y} is the acceleration measured by the accelerometric sensor on the axis y″ of the sensor.

The speed of travel of the vehicle may then be calculated as a temporal integration of the acceleration value:

vₜᵣₐᵢₙ(t)=∫₀^{t}aₜᵣₐᵢₙdt (3)

or, in the case of discrete acquisition systems:

Vₜᵣₐᵢₙ(t)=Σ₀ⁿaₜᵣₐᵢₙ*ΔT (4)
where ΔT is the sampling period of the electronic acquisition system and n is the number of samples acquired at the time t.

However, this methodology, which has been greatly simplified by the above assumptions, is not actually applicable in a real context.

Although it may be mounted with precision, the accelerometric sensor that is integrated in an electronic circuit board on board the vehicle will not have its sensitive axes x″, y″ and z″ perfectly aligned with those of the vehicle x′, y′ and z′.

Moreover, the hypothesis that the vehicle 1 is travelling on a section of track 3 that is perfectly straight and has no gradient is not applicable in practice either, because the railway vehicle may travel on sections that are curved and/or have a non-zero gradient.

The invalidity of the aforementioned assumptions opens the way to geometric scenarios in which the three reference systems (gravitational, vehicle and accelerometer) have relative angles on the 3 axes.

The angles of rotation between the vehicle reference system and the gravitational reference system may be defined as α, β, φ, for the axes x, y, z, respectively.

The angles of rotation between the accelerometer reference system and the vehicle reference system may be defined as α′, β′, φ′, for the axes x, y, z, respectively.

The angles α, β, φ are unknown to the electronic unit that acquires the accelerometer, but they are constant over time since they depend only on the mounting of the accelerometer relative to the vehicle.

The angles α′, β′, φ′, as well as being unknown to the electronic unit that acquires the accelerometer, are not constant over time since they depend on the curvature and gradient of the local section of track.

Since the angles α, β, φ and the angles α′, β′, φ′ are unknown and unrelated to each other, the problem of determining the longitudinal acceleration of the vehicle from the measurements of a triaxial accelerometer mounted on board the vehicle may not be solved analytically and/or geometrically.

For example, WO2017042138 proposes an analytical/geometric method for determining the orientation of an accelerometric sensor with respect to the vehicle on which the sensor is mounted. This method is based on the availability of:
a “free state,” i.e. a state of a railway vehicle that is stationary or at a constant speed, in which state the accelerometric sensor is subjected only to the gravitational force;
availability, even discontinuous availability, of a source of speed of the railway vehicle that is reliable and external to the accelerometer.

The availability, even discontinuous availability, of a reliable measurement of speed of the railway vehicle that is external to the accelerometer is plausible if one considers that the angular speed of the axles (measured by the sensors SS in FIG. 1) is reliable in all cases of non-degraded adhesion, which are still the majority. The role of the accelerometric sensor, and of the method for estimating the speed of the railway vehicle therefrom, will be that of being used in situations of degraded adhesion in which the axles are all in slippage and their angular speed is not representative of the speed of the railway vehicle or train.

However, the method proposed in WO2017042138 is fundamentally based on two assumptions:
during the “free state,” the vehicle is on a perfectly level section of track (gradient equal to zero);
in the phases of using the speed external to the accelerometer, the railway vehicle or train is on a perfectly straight section of track. The transverse acceleration component (axis x) is therefore disregarded and is instead present in the curvilinear sections.

The assumptions on which WO2017042138 is based are greatly limiting and do not ensure the operation of this method in a real application.

The most commonly used algorithm for estimating the real speed V_{V}(t) of the vehicle, in the event of braking, normally uses a function such as:

Vᵥ(Tⱼ)=max [S₁(Tⱼ), . . . , Sₙ(Tⱼ₋₁), (Vᵥ(Tⱼ₋₁)+aₘₐₓ·T)] (5)
whereas in the event of traction it uses the function

Vᵥ(Tⱼ)=min [S₁(Tⱼ), . . . , Sₙ(Tⱼ₋₁), (Vᵥ(Tⱼ₋₁)+aₘₐₓ·T)] (6)

where aₘₐₓ represents the maximum acceleration allowed in operation by the vehicle, this acceleration having a positive sign in traction conditions and a negative sign in braking conditions. The contribution (Vᵥ(Tⱼ₋₁)+aₘₐₓ·T) in formulas (5) and (6) is used to contain the variation of V_{V}(t) within physical limits allowed by the train, when excessive instantaneous and simultaneous variations of the axle speeds due to particularly degraded adhesion conditions during traction or braking could lead to a significant loss in the speed V_{V}(t) calculated using formulas (5) and (6).

More accurate variants of formulas (5) and (6) are known, but are still based on the instantaneous measurement of the individual speed of the axles. Here it is clear that the availability of an idle axle would make formulas (5) and (6) extremely accurate if all the axles subjected to torque were in the slippage phase.

### SUMMARY OF THE INVENTION

An object of this invention is therefore to provide a method for estimating a longitudinal acceleration of at least one railway vehicle and a method for estimating a longitudinal speed of at least one railway vehicle, which methods allow, respectively, the longitudinal acceleration and the longitudinal speed of the vehicle to be measured even in a condition in which all of the axles of said vehicle are in a slippage phase caused by degraded adhesion.

A further object of this invention is therefore to allow the use of the idle axle to be fully recovered for traction and braking purposes, even in the case of particularly low adhesion, thus increasing the traction and braking capacity of the train while allowing said axis to accurately track the speed of the train in order to accurately evaluate the longitudinal forward speed.

The method for estimating a longitudinal speed and the method for estimating a longitudinal acceleration may be applied to both slippage situations in a traction phase (negative V_{slippage}) and slippage situations in a braking phase (positive V_{slippage}).

This invention allows for the most precise knowledge of the longitudinal speed of a railway vehicle, so as to facilitate and improve, for example, the piloting of control systems, anti-slippage systems, and odometric references installed on board.

The aforesaid and other objects and advantages are achieved, according to an aspect of the invention, by a method for estimating a longitudinal acceleration of at least one railway vehicle having the features defined in claim 1 and in claim 2, respectively, and by methods for estimating a longitudinal acceleration of at least one railway vehicle having the features defined in the respective claims 10 and 12. Preferred embodiments of the invention are defined in the dependent claims, the content of which is to be understood as an integral part of the present description.

### BRIEF DESCRIPTION OF THE DRAWINGS

The functional and structural features of some preferred embodiments of a method for estimating a longitudinal speed of at least one railway vehicle according to the invention will now be described. Reference is made to the appended drawings, in which:

FIG. 1 shows a WSP system produced in accordance with the prior art;

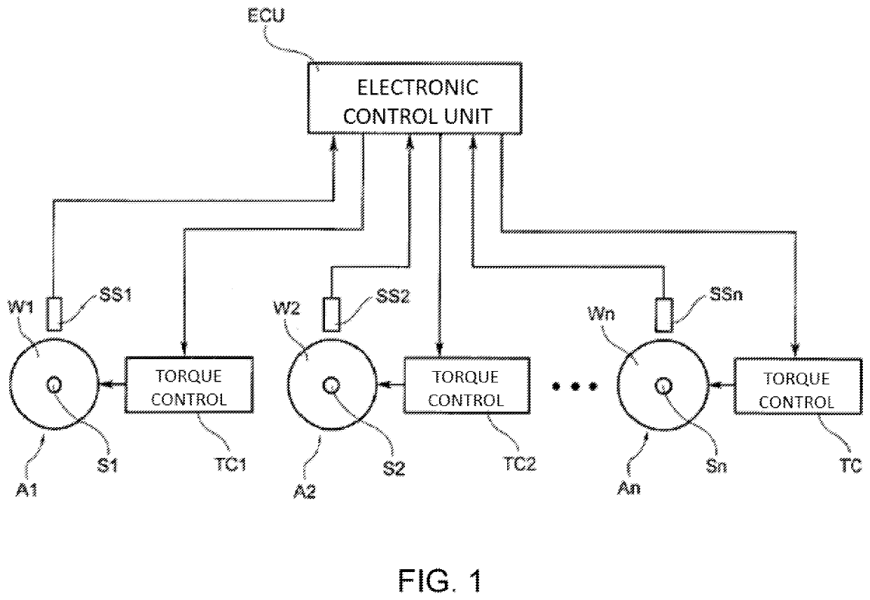

FIG. 2a shows an example composition comprising two independent cars while FIG. 2.b shows an example composition comprising two cars constrained by means of a Jacobs bogie;

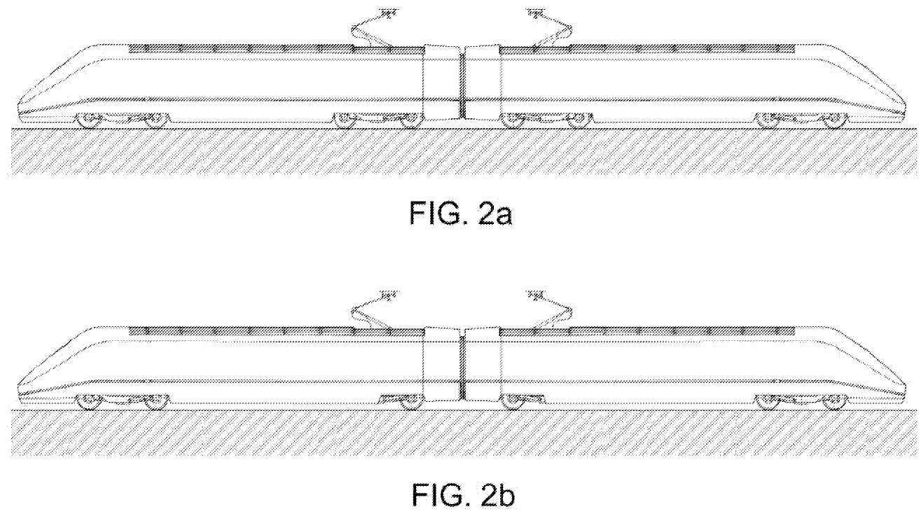

FIG. 3 shows a railway vehicle travelling on a track and provided with an accelerometric sensor;

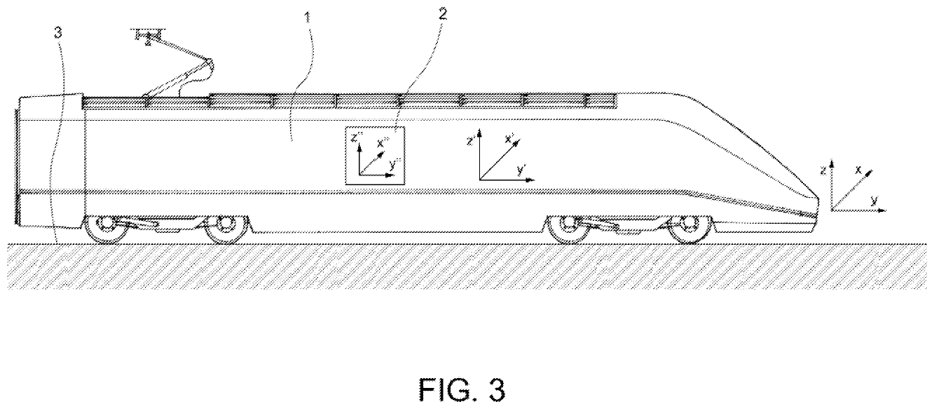

FIG. 4 shows an example system which may be used to implement an embodiment of this invention; and

FIG. 5 shows a plurality of explanatory graphs of the trend over time of the speed of the railway vehicle, the availability of the independent longitudinal reference speed and the direction cosines.

### DETAILED DESCRIPTION

Before describing a plurality of embodiments of the invention in detail, it should be clarified that the invention is not limited in its application to the construction details and configuration of the components presented in the following description or illustrated in the drawings. The invention is capable of assuming other embodiments and of being implemented or constructed in practice in different ways. It should also be understood that the phraseology and terminology have a descriptive purpose and should not be construed as limiting. The use of “include” and “comprise” and their variations is to be understood as encompassing the elements set out below and their equivalents, as well as additional elements and the equivalents thereof.

This invention proposes a method for calculating an estimated longitudinal acceleration of at least one railway vehicle, and thereafter a method for calculating an estimated longitudinal speed of the railway vehicle, using an accelerometric sensor means, for example a triaxial accelerometric sensor means.

The method for estimating a longitudinal acceleration of at least one railway vehicle requires the availability, even discontinuous availability, of a measurement of the speed of the train that is independent from the accelerometer, in the following referred to as the independent longitudinal reference speed V_{ref} of the railway vehicle. The method for estimating a longitudinal acceleration of at least one railway vehicle is based on obtaining the direction cosines of a 3×3 orientation matrix such that, if multiplied by the measurements from the sensor having 3 orthogonal axes, an estimated longitudinal acceleration of the vehicle is obtained. By integrating the estimated longitudinal acceleration of the vehicle, it is possible to obtain an estimated longitudinal speed of the vehicle.

The main equation used is as follows:

k₁*aₓ(t)+k₂*a_{y}(t)+k₃*a_{z}(t)=a_{ref}(t) (7)
where:
k₁, k₂ and k₃ are numerical values of direction cosines, k₁, k₂ and k₃ being the variables of the equation;
aₓ(t), a_{y}(t), a_{z}(t) are accelerations detected by the accelerometric sensor means on its three orthogonal axes in a generic instant t;
a_{ref}(t) is an independent reference acceleration at the instant t, determined by means of a derivative at the instant t of an independent reference longitudinal speed (i.e. travel speed) v_{ref}, i.e.:

$${a}_{ref} ( t ) = \frac{{dv}_{ref}}{dt} ( t )$$

In order for it to be possible to calculate the derivative of the independent longitudinal reference speed at the instant t, this independent longitudinal reference speed must be measured for at least one time interval containing the instant t. For example, the interval may be 20 ms, 100 ms, etc.

The unknowns of this equation are the values of k₁, k₂ and k₃.

Equation (7) is valid only in cases in which the independent longitudinal reference speed v_{ref} described above is available.

Regardless of the technique used, solving equation (7) during the phases in which the independent longitudinal reference speed v_{ref} is available means that the coefficients k₁, k₂ and k₃ may be dynamically updated such that their linear combination with the accelerations measured by the sensor results in the estimated longitudinal acceleration of the railway vehicle or train.

In the following, a first embodiment of a method for estimating a longitudinal acceleration of at least one railway vehicle by means of an accelerometric sensor means 100 is described. The accelerometric sensor means 100 is arranged to measure a first acceleration aₓ along a first axis x, a second acceleration a_{y} along a second axis y and a third acceleration a_{z} along a third axis z. The first axis x, the second axis y and the third axis z are orthogonal to each other.

The method for estimating a longitudinal acceleration of at least one railway vehicle comprises a first calibration phase which includes the steps of:
measuring, in a first calibration instant t_{c1} in which an independent longitudinal reference speed v_{ref} of the railway vehicle is available, a first value of the first acceleration aₓ(t_{c1}), a first value of the second acceleration a_{y}(t_{c1}) and a first value of the third acceleration a_{z}(t_{c1}), wherein the independent longitudinal reference speed vref is independent from said accelerometric sensor means (100);
measuring, in a second calibration instant t_{c2} in which said independent longitudinal reference speed v_{ref} of the railway vehicle is available, which second calibration instant is different from said first calibration instant t_{c1}, a second value of the first acceleration aₓ(t_{c2}), a second value of the second acceleration a_{y}(t_{c2}) and a second value of the third acceleration a_{z}(t_{c2});
measuring, in a third calibration instant t_{c3} in which said independent longitudinal reference speed v_{ref} of the railway vehicle is available, which third calibration instant is different from said first calibration instant t_{c1} and from said second calibration instant t_{c2}, a third value of the first acceleration aₓ(t_{c3}), a third value of the second acceleration a_{y}(t_{c3}) and a third value of the third acceleration a_{z}(t_{c3});
calculating the value of a first independent longitudinal reference acceleration a_{ref}(t_{c1}) in the first calibration instant t_{c1} from a first value of the independent longitudinal reference speed v_{ref}(t_{c1}) measured in the first calibration instant t_{c1};
calculating the value of a second independent longitudinal reference acceleration a_{ref}(t_{c2}) in the second calibration instant t_{c2} from a second value of the independent longitudinal reference speed v_{ref}(t_{c2}) measured in the second calibration instant t_{c2};
calculating the value of a third independent longitudinal reference acceleration a_{ref}(t_{c3}) in the third calibration instant t_{c3}from a third value of the independent longitudinal reference speed v_{ref}(t_{c3}) measured in the third calibration instant t_{c3};
solving the following system, in order to determine the values of the first direction cosine k₁, the second direction cosine k₂ and the third direction cosine k₃;

$$\{ \begin{matrix}{k}_{1} * {a}_{x} ( {t}_{c 1} ) + {k}_{2} * {a}_{y} ( {t}_{c 1} ) + {k}_{3} * {a}_{z} ( {t}_{c 1} ) = {a}_{ref} ( {t}_{c 1} ) \\ {k}_{1} * {a}_{x} ( {t}_{c 2} ) + {k}_{2} * {a}_{y} ( {t}_{c 2} ) + {k}_{3} * {a}_{z} ( {t}_{c 2} ) = {a}_{ref} ( {t}_{c 2} ) \\ {k}_{1} * {a}_{x} ( {t}_{c 3} ) + {k}_{2} * {a}_{y} ( {t}_{c 3} ) + {k}_{3} * {a}_{z} ( {t}_{c 3} ) = {a}_{ref} ( {t}_{c 3} )\end{matrix} \qquad ( 8 )$$

Clearly, the calibration instants may all be obtained in a single continuous calibration interval in which the independent longitudinal reference speed of the railway vehicle is available, or the calibration instants may be obtained in several calibration intervals in which the independent longitudinal reference speed of the railway vehicle is available. In the second case, the various calibration intervals may be separated by intervals in which the independent longitudinal reference speed of the railway vehicle is not available.

In other words, it is possible to measure of values of aₓ, a_{y}, a_{z} and v_{ref} in three different calibration instants t_{c1}, t_{c2}, t_{c3} provided that the independent longitudinal reference speed v_{ref} is available, so as to have a system of three equations. This system of three equations in three unknowns may be solved both by an analytical method and by a numerical method. Furthermore, by acquiring the measurements at further instants (i.e. more than 3 times), it is possible to recursively increase and update the accuracy of the solutions k₁, k₂, k₃ over time.

In the present case, saying that the independent longitudinal reference speed v_{ref} is independent from the accelerometric sensor means 100 is understood to mean that the independent longitudinal reference speed is not a speed obtained by means of said accelerometric sensor means.

In the present case, stating that the independent longitudinal reference speed v_{ref} is available may be understood to mean the case in which the independent longitudinal reference speed v_{ref} may be used in the method for estimating a longitudinal acceleration of at least one railway vehicle that is the subject of the present invention since it is accessible and reflects the real longitudinal speed at which the railway vehicle is moving along a track.

The method for estimating a longitudinal acceleration of at least one railway vehicle also comprises a further measurement phase following said calibration phase.

This measurement phase comprises the steps of:
determining, for at least a first measurement instant tᵢ₁ in which said independent longitudinal reference speed of the railway vehicle is not available, an estimated longitudinal acceleration value at₁ₒₙ(tᵢ₁) of the at least one railway vehicle.

The estimated longitudinal acceleration value a₁ₒₙ(tᵢ₁) is relative to said measurement instant tᵢ₁ and is estimated by means of the sum of:
a multiplication of the first direction cosine k₁, determined during the calibration phase, with a fourth value of the first acceleration aₓ(tᵢ₁) acquired in said first measurement instant tᵢ₁;
a multiplication of the second direction cosine k₂, determined during the calibration phase, with a fourth value of the second acceleration a_{y}(tᵢ₁) acquired in said first measurement instant tᵢ₁;
a multiplication of the third direction cosine k₃, determined during the calibration phase, with a fourth value of the third acceleration a_{z}(tᵢ₁) acquired in said first measurement instant tᵢ₁.

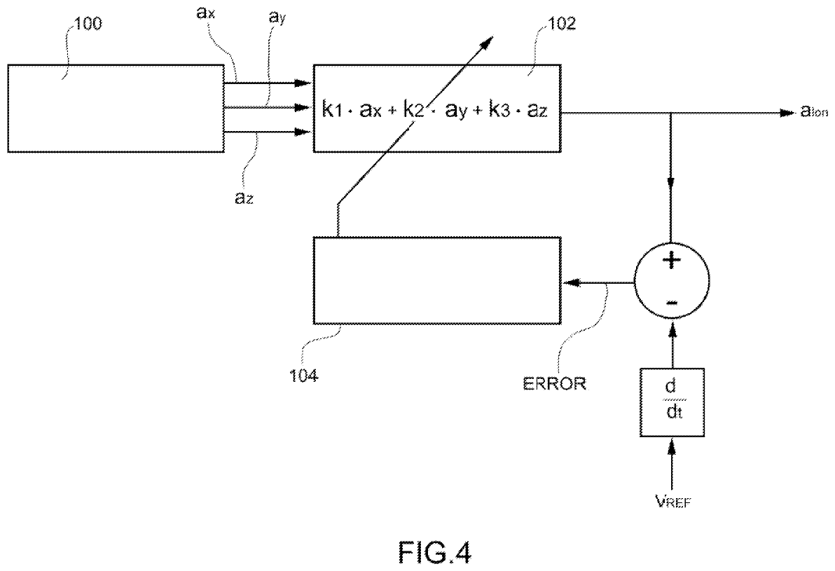

In one alternative embodiment, with reference to FIG. 4, the method for estimating a longitudinal speed of at least one railway vehicle again comprises a calibration phase which includes the step of:
estimating, by means of a linear filter, for at least a first calibration instant t_{c1} in which an independent longitudinal reference speed v_{ref} of the railway vehicle is available, an estimated longitudinal acceleration value a₁ₒₙ(t_{c1}) of the at least one railway vehicle. The independent longitudinal reference speed v_{ref} is also independent from said accelerometric sensor means 100 in this case.

The estimated longitudinal acceleration value a₁ₒₙ(t_{c1}) is relative to said calibration instant t_{c1} and is estimated by the linear filter by means of the sum of:
a multiplication of a first direction cosine k₁ having a predetermined value with a first value of the first acceleration aₓ(t_{c1}) acquired in said first calibration instant t_{c1};
a multiplication of a second direction cosine k₂ having a predetermined value with a first value of the second acceleration a_{y}(t_{c1}) acquired in said first calibration instant t_{c1};
a multiplication of a third direction cosine k₃ having a predetermined value with a first value of the third acceleration a_{z}(t_{c1}) acquired in said first calibration instant t_{c1}.

In this embodiment, the calibration phase also includes the steps of:
determining an estimate error, Error, by means of the difference between the estimated longitudinal acceleration value a₁ₒₙ(t_{c1}), relative to said first calibration instant t_{c1}, and an independent longitudinal reference acceleration value a_{ref}(t_{c1}) which is relative to the first calibration instant t_{c1} and determined from a first value of the independent longitudinal reference speed value v_{ref}(t_{c1}) measured in the first calibration instant t_{c1};
determining, by means of an adaptive filter (104), respective updated values of the first direction cosine k₁, the second direction cosine k₂ and the third direction cosine k₃ to be imposed onto said linear filter in order to minimize said estimate error.

When the calibration phase is started for the first time, the values of the first direction cosine k₁, the second direction cosine k₂ and the third direction cosine k₃ may be predetermined. For example, they may be a predetermined default value that will be gradually adjusted as the calibration is performed in various calibration instants, or they may be a predetermined value equivalent to the value of the first direction cosine k₁, the second direction cosine k₂ and the third direction cosine k₃ that were calibrated during a previous operation of the railway vehicle.

In other words, solving the equation may be based on the use of adaptive algorithms. The error may be obtained by comparing the output of the linear filter with the reference longitudinal acceleration value obtained by deriving the independent longitudinal reference speed v_{ref}. This error is used by the adaptive filter to dynamically recalculate the coefficients of the linear filter k₁, k₂, k₃ in order to recursively minimize the error.

In this alternative embodiment too, the method for estimating a longitudinal speed of at least one railway vehicle also comprises a further measurement phase following said calibration phase.

This measurement phase comprises the step of:
determining, by means of said linear filter, for at least a first measurement instant tᵢ₁ in which said independent longitudinal reference speed of the railway vehicle is not available, an estimated longitudinal acceleration value a₁ₒₙ(tᵢ₁) of the at least one railway vehicle.

The estimated longitudinal acceleration value a₁ₒₙ(tᵢ₁) is relative to said measurement instant tᵢ₁ and is estimated by means of the sum of:
a multiplication of the updated value of the first direction cosine k₁, determined during the calibration phase, with a value of the first acceleration aₓ(tᵢ₁) acquired in said first measurement instant tᵢ₁;
a multiplication of the updated value of the second direction cosine k₂, determined during the calibration phase, with a value of the second acceleration a_{y}(tᵢ₁) acquired in said first measurement instant tᵢ₁;
a multiplication of the updated value of the third direction cosine k₃, determined during the calibration phase, with a value of the third acceleration a_{z}(tᵢ₁) acquired in said first measurement instant tᵢ₁.

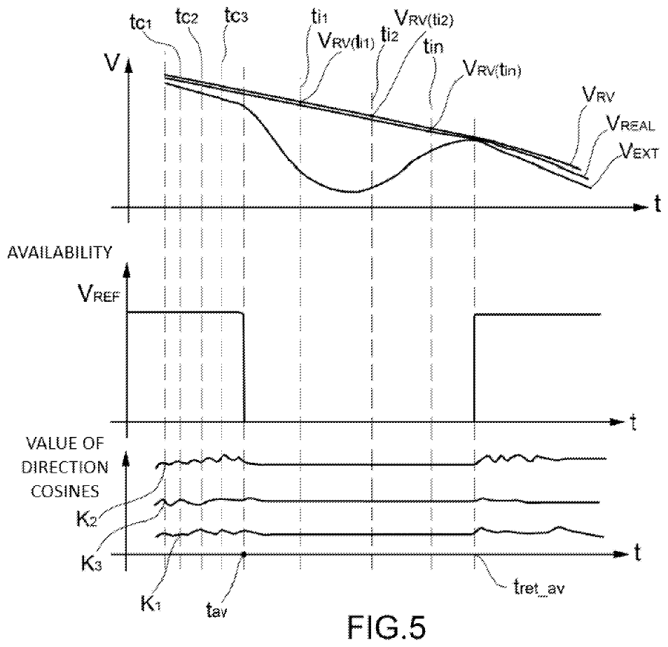

With reference to FIG. 5, an availability instant tₐᵥ may be defined as the last instant in which the independent longitudinal reference speed v_{ref} is available. The instant following the availability instant tₐᵥ will be an instant in which the independent longitudinal reference speed v_{ref} will no longer be available.

The independent longitudinal reference speed v_{ref}(tₐᵥ), detected at the instant tₐᵥ, is the last available reliable value of the independent longitudinal reference speed v_{ref}.

A return to availability instant t_{ret_av}, where t_{ret_av}>tₐᵥ, may also be defined as the first instant in which the independent longitudinal reference speed v_{ref} becomes available again.

The measurement instant tᵢ₁ may coincide with the return to availability instant t_{ret_av}.

The equation

k₁*aₓ(t)+k₂*a_{y}(t)+k₃*a_{z}(t)=a_{ref}(t)
is applicable only in the periods of availability of the independent longitudinal reference speed v_{ref}, i.e. in the periods (t<tₐᵥ) and (t>t_{ret_av}).

By solving this equation, the coefficients k₁, k₂, k₃ will be dynamically updated up to the availability instant tₐᵥ. In the time period between tₐᵥ and t_{ret_av}, the values of k₁, k₂, k₃ will be frozen at their last value updated at the availability instant tₐᵥ, k₁(tₐᵥ), k₂(tₐᵥ), k₃(tₐᵥ)). Then, with t>tₐᵥ, the values of k₁, k₂, k₃ may be dynamically updated by solving equation (7).

For example, the first measurement instant tᵢ₁ may coincide with an instant in which said independent longitudinal reference speed v_{ref}(t_{ret_av}) becomes available again after being unavailable.

The adaptive filter may be arranged to determine the respective updated values of the first direction cosine k₁, the second direction cosine k₂ and the third direction cosine k₃ through an adaptive algorithm based on a least means square technique, LMS.

For all of the embodiments described above, the calibration phase may be repeated for a plurality of calibration instants, for example a second calibration instant tᵢ₂, a third calibration instant tᵢ₃, . . . , an n-th calibration instant tᵢₙ.

Clearly, the calibration step may be performed at each first ignition of the at least one railway vehicle.

In the following, some examples of the independent longitudinal reference speed v_{ref} of the railway vehicle will be given.

For example, the independent longitudinal reference speed v_{ref} may be a longitudinal speed obtained from an angular speed of an axle of the railway vehicle. In this case, the independent longitudinal reference speed v_{ref} may be available when the axle is not slipping.

In a further example, the independent longitudinal reference speed v_{ref} of the railway vehicle is a longitudinal speed of the railway vehicle provided by a positioning means. In this case, the independent longitudinal reference speed v_{ref} may be available when said positioning means communicates with a satellite. The positioning means may be a GPS system/device which communicates using a suitable signal to obtain the location information and therefore the speed of movement of the train. The independent longitudinal reference speed v_{ref} may not be available when, for example, the railway vehicle is inside a tunnel and is not able to communicate with said satellite.

In a further aspect of the invention, the estimated longitudinal acceleration a₁ₒₙ may be determined for a plurality of measurement times tᵢ₁, tᵢ₂, . . . , tᵢₙ in which the independent longitudinal reference speed v_{ref} of the railway vehicle is available, for example a second measurement instant tᵢ₂, a third measurement instant tᵢ₃, . . . , an n-th measurement instant tᵢₙ. The plurality of measurement times tᵢ₁, tᵢ₂, . . . , tᵢₙ may be selected according to an acquisition period ΔTᵢ.

Or, the estimated longitudinal acceleration a₁ₒₙ may be continuously determined from an availability instant tₐᵥ coinciding with an instant that directly precedes an unavailability instant in which said independent longitudinal reference speed v_{ref} of the railway vehicle is no longer available, and a measurement instant, for example the first measurement instant tᵢ₁ or the successive measurement instants tᵢ₂, . . . , tᵢₙ.

This invention also relates to a method for estimating a longitudinal speed of at least one railway vehicle.

When the estimated longitudinal acceleration a₁ₒₙ is determined for a plurality of measurement times tᵢ₁, tᵢ₂, . . . , tᵢₙ in which the independent longitudinal reference speed v_{ref} of the rail vehicle is available, which measurement times were selected according to an acquisition period ΔTᵢ, the method for estimating a longitudinal speed of at least one railway vehicle comprises the step of measuring the value of the independent longitudinal reference speed v_{ref}(tₐᵥ) of the at least one axle of the railway vehicle in the availability instant tₐᵥ.

The method for estimating a longitudinal speed of at least one railway vehicle also comprises the step of determining the longitudinal speed v_{RV}(tᵢₙ) of the railway vehicle according to the following steps:
calculating the sum of the longitudinal accelerations estimated in the plurality of measurement times tᵢ₁, tᵢ₂, . . . , tᵢₙ;
multiplying the sum of the longitudinal accelerations determined in the plurality of measurement times tᵢ₁, tᵢ₂, . . . , tᵢₙ by the acquisition period ΔTᵢ;
adding the value of the independent longitudinal reference speed V_{ref}(tₐᵥ) of said at least one railway vehicle in the availability instant tₐᵥ to the result of the multiplication of the sum of the estimated longitudinal accelerations determined in the plurality of measurement times tᵢ₁, tᵢ₂, . . . , tᵢₙ by the acquisition period ΔTᵢ.

For example, the step of determining the longitudinal speed v_{RV} of the railway vehicle may be carried out using the following formula:

v_{RV}(tᵢₙ)=v_{ref}(tₐᵥ)+Σ₀ⁿaₗₒₙ*ΔTᵢ
where:
v_{ref}(tₐᵥ) is the independent longitudinal reference speed V_{ref}(tₐᵥ) of said at least one railway vehicle in the availability instant tₐᵥ;
Σ₀ⁿaₗₒₙ is the sum of the longitudinal accelerations estimated in the plurality of measurement instants tᵢ₁, tᵢ₂, . . . , tᵢₙ and n is the number of acquisition periods elapsed between the availability instant tₐᵥ and the measurement instant (tᵢₙ) of which the longitudinal speed v_{RV}(tᵢₙ) is under determination; and
ΔTᵢ is the acquisition period.

When instead the estimated longitudinal acceleration a₁ₒₙ is determined continuously from the availability instant tₐᵥ, coinciding with an instant directly preceding an unavailability instant in which said independent longitudinal reference speed v_{ref} is not available, and for example a first measurement instant tᵢ₁, the method for estimating a longitudinal speed of at least one railway vehicle comprises the step of measuring the value of the independent longitudinal reference speed v_{ref}(tₐᵥ) of said at least one railway vehicle in the availability instant tₐᵥ.

The method for estimating a longitudinal speed of at least one railway vehicle also comprises the step of determining the longitudinal speed v_{RV}(t) of the railway vehicle according to the following steps:
calculating the integral of the estimated longitudinal acceleration a₁ₒₙ determined continuously from the availability instant tₐᵥ to said first measurement instant tᵢ₁;
adding the value of the independent longitudinal reference speed V_{ref}(tₐᵥ) of said at least one railway vehicle in the availability instant tₐᵥ to the result of the integral of the estimated longitudinal acceleration.

For example, the step of determining the longitudinal speed v_{RV}(tᵢ₁) of the railway vehicle may be carried out using the following formula:

v_{RV}(tᵢ₁)=v_{ref}(tₐᵥ)+∫ₜ_{ₐᵥ}^{t}^{ᵢ₁}aₗₒₙdt
where:
v_{ref}(tₐᵥ) is the independent longitudinal reference speed V_{ref}(tₐᵥ) in the availability instant tₐᵥ;
∫ₜ_{ₐᵥ}^{t}^{ᵢ₁}aₗₒₙdt is the integral of the estimated longitudinal acceleration aₗₒₙ determined continuously from the availability instant tₐᵥ to the first measurement instant tᵢ₁ of which the longitudinal speed v_{RV}(tᵢ₁) is under determination.

The above is also valid for the subsequent measurement instants. For example, considering an n-th measurement time tᵢₙ, the step of determining the longitudinal speed v_{RV}(tᵢₙ) of the railway vehicle may be carried out using the following formula:

v_{RV}(tᵢₙ)=v_{ref}(tₐᵥ)+∫ₜ_{ₐᵥ}^{t}^{ᵢₙ}aₗₒₙdt
where:
v_{ref} (tₐᵥ) is the independent longitudinal reference speed V_{ref}(tₐᵥ) in the availability instant tₐᵥ;
∫ₜ_{ₐᵥ}^{t}^{ᵢₙ}aₗₒₙdt is the integral of the estimated longitudinal acceleration aₗₒₙ determined continuously from the availability instant tₐᵥ to the n-th measurement instant tᵢₙ of which the longitudinal speed v_{RV}(tᵢₙ) is under determination.

Again with reference to FIG. 5, it may therefore be summarized that, during the time period between tₐᵥ and t_{ret_av}, with the independent longitudinal reference speed v_{ref} not being available, the acceleration of the railway vehicle will be calculated from the measurements of the accelerometer.

During the time period between tₐᵥ and t_{ret_av}, with the independent longitudinal reference speed v_{ref} not being available, the speed of the railway vehicle will be calculated using the measurements from the accelerometer and the last reliable independent longitudinal reference speed value v_{ref} according to the equations shown above.

Advantageously, because of that which has been described above in the present description, the longitudinal speed of the railway vehicle v_{RV} will always be available, even in the phases in which the independent longitudinal reference speed v_{ref} is not available. Because of this, it is also possible to fully recover the use of the idle axle for traction and braking purposes, even in the case of particularly low adhesion, thus increasing the traction and braking capacity of the train.

Various aspects and embodiments of a method for estimating a longitudinal acceleration of at least one railway vehicle and a method for estimating a longitudinal speed of at least one railway vehicle according to the invention have been described. It is understood that each embodiment may be combined with any other embodiment. Furthermore, the invention is not limited to the described embodiments, but may be varied within the scope defined by the appended claims.

1. Method for estimating a longitudinal acceleration of at least one railway vehicle by means of an accelerometric sensor means arranged to measure a first acceleration aₓ along a first axis x, a second acceleration a_{y} along a second axis y and a third acceleration a_{z} along a third axis z, wherein the first axis x, the second axis y and the third axis z are orthogonal to each other;
the method for estimating the longitudinal acceleration of at least one railway vehicle comprising the steps of:
executing a calibration phase including the steps of:
measuring, in a first calibration instant t_{c1} in which an independent longitudinal reference speed v_{ref} of the railway vehicle is available, a first value of a first acceleration aₓ(t_{c1}), a first value of a second acceleration a_{y}(t_{c1}) and a first value of a third acceleration a_{z}(t_{c1}); an independent longitudinal reference speed v_{ref} being independent from said accelerometric sensor means;
measuring, in a second calibration instant t_{c2} in which said independent longitudinal reference speed v_{ref} of the railway vehicle is available, which second calibration instant is different from said first calibration instant t_{c1}, a second value of the first acceleration aₓ(t_{c2}), a second value of the second acceleration aₓ(t_{c2}) and a second value of the third acceleration a_{z}(t_{c2});
measuring, in a third calibration instant t_{c3} in which said independent longitudinal reference speed v_{ref} of the railway vehicle is available, which third calibration instant is different from said first calibration instant t_{c1} and from said second calibration instant t_{c2}, a third value of the first acceleration aₓ(t_{c3}), a third value of the second acceleration a_{y}(t_{c3}) and a third value of the third acceleration a_{z}(t_{c3});
calculating the value of a first independent longitudinal reference acceleration a_{ref}(t_{c1}) in the first calibration instant t_{c1} from a first value of the independent longitudinal reference speed v_{ref}(t_{c1}) measured in the first calibration instant t_{c1};
calculating the value of a second independent longitudinal reference acceleration a_{ref}(t_{c2}) in the second calibration instant t_{c2} from a second value of the independent longitudinal reference speed v_{ref}(t_{c2}) measured in the second calibration instant t_{c2};
calculating the value of a third independent longitudinal reference acceleration a_{ref}(t_{c3}) in the third calibration instant t_{c3} from a third value of the independent longitudinal reference speed v_{ref}(t_{c3}) measured in the third calibration instant t_{c3};
solving the following system, in order to determine the-values of a first direction cosine k₁, a second direction cosine k₂ and a third direction cosine k₃:
$$\{ \begin{matrix}{k}_{1} * {a}_{x} ( {t}_{c 1} ) + {k}_{2} * {a}_{y} ( {t}_{c 1} ) + {k}_{3} * {a}_{z} ( {t}_{c 1} ) = {a}_{ref} ( {t}_{c 1} ) \\ {k}_{1} * {a}_{x} ( {t}_{c 2} ) + {k}_{2} * {a}_{y} ( {t}_{c 2} ) + {k}_{3} * {a}_{z} ( {t}_{c 2} ) = {a}_{ref} ( {t}_{c 2} ) \\ {k}_{1} * {a}_{x} ( {t}_{c 3} ) + {k}_{2} * {a}_{y} ( {t}_{c 3} ) + {k}_{3} * {a}_{z} ( {t}_{c 3} ) = {a}_{ref} ( {t}_{c 3} )\end{matrix}$$
following the calibration phase, determining, for at least a first measurement instant tᵢ₁ in which said independent longitudinal reference speed of the railway vehicle is not available, an estimated longitudinal acceleration value a₁ₒₙ(tᵢ₁) of the at least one railway vehicle, wherein said estimated longitudinal acceleration value a₁ₒₙ(tᵢ₁) is relative to said first measurement instant tᵢ₁ and is estimated by means of the sum of:
a multiplication of the first direction cosine k₁, determined during the calibration phase, with a fourth value of the first acceleration aₓ(tᵢ₁) acquired in said first measurement instant tᵢ₁ ;
a multiplication of the second direction cosine k₂, determined during the calibration phase, with a fourth value of the second acceleration a_{y}(tᵢ₁) acquired in said first measurement instant tᵢ₁ ;
a multiplication of the third direction cosine k₃, determined during the calibration phase, with a fourth value of the third acceleration a_{z}(tᵢ₁) acquired in said first measurement instant tᵢ₁ .

2. Method for estimating a longitudinal acceleration of at least one railway vehicle by means of an accelerometric sensor means arranged to measure a first acceleration aₓ along a first axis x, a second acceleration a_{y} along a second axis y and a third acceleration a_{z} along a third axis z, wherein the first axis x, the second axis y and the third axis z are orthogonal to each other;
the method for estimating a longitudinal acceleration of at least one railway vehicle comprising the steps of:
executing a calibration phase including the steps of:
for at least a first calibration instant t_{c1} in which an independent longitudinal reference speed v_{ref} of the railway vehicle is available, wherein the independent longitudinal reference speed v_{ref} is independent from said accelerometric sensor means, estimating an estimated longitudinal acceleration value a₁ₒₙ(t_{c1}) of the at least one railway vehicle by means of a linear filter; wherein said estimated longitudinal acceleration value a₁ₒₙ(t_{c1}) is relative to said first calibration instant t_{c1} and is estimated by the linear filter by means of the sum of:
a multiplication of a first direction cosine k₁ having a predetermined value with a first value of the first acceleration aₓ(t_{c1}) acquired in said first calibration instant t_{c1};
a multiplication of a second direction cosine k₂ having a predetermined value with a first value of the second acceleration a_{y}(t_{c1}) acquired in said first calibration instant t_{c1};
a multiplication of a third direction cosine k₃ having a predetermined value with a first value of the third acceleration a_{z}(t_{c1}) acquired in said first calibration instant t_{c1};
determining an estimate error (Error) by means of a difference between the estimated longitudinal acceleration value aₗₒₙ(t_{c1}), relative to said first calibration instant t_{c1}, and a reference longitudinal acceleration value a_{ref}(t_{c1}) which is relative to the first calibration instant t_{c1} and determined from a first value of the independent reference longitudinal speed value v_{ref}(t_{c1}) measured in the first calibration instant t_{c1};
determining, by means of an adaptive filter, respective updated values of the first direction cosine k₁, the second direction cosine k₂ and the third direction cosine k₃ to be imposed onto said linear filter in order to minimize said estimate error;
following the calibration phase, determining by means of said linear filter, for at least a first measurement instant tᵢ₁ in which said independent longitudinal reference speed of the railway vehicle is not available, an estimated longitudinal acceleration value a₁ₒₙ(tᵢ₁) of the at least one railway vehicle, wherein said estimated longitudinal acceleration value a₁ₒₙ(tᵢ₁) is relative to said first measurement instant tᵢ₁ and is estimated by means of the sum of:
a multiplication of the updated value of said first direction cosine k₁, determined during the calibration phase, with a second value of the first acceleration aₓ(tᵢ₁) acquired in said first measurement instant tᵢ₁;
a multiplication of the updated value of said second direction cosine k₂, determined during the calibration phase, with a second value of the second acceleration a_{y}(tᵢ₁) acquired in said first measurement instant tᵢ₁;
a multiplication of the updated value of said third direction cosine k₃, determined during the calibration phase, with a second value of the third acceleration a_{z}(tᵢ₁) acquired in said first measurement instant tᵢ₁.

3. The method for estimating a longitudinal acceleration of at least one railway vehicle according to claim 2, wherein said adaptive filter is arranged to determine said respective updated values of the first direction cosine k₁, the second direction cosine k₂ and the third direction cosine k₃ through an adaptive algorithm based on a least means square technique, LMS.

4. The method for estimating a longitudinal acceleration of at least one railway vehicle according to claim 1, wherein the calibration phase is repeated for a plurality of calibration instants.

5. The method for estimating a longitudinal acceleration of at least one railway vehicle according to claim 1, wherein the calibration phase is performed at each first ignition of the at least one railway vehicle.

6. The method for estimating a longitudinal acceleration of at least one railway vehicle according to claim 1, wherein said independent longitudinal reference speed v_{ref} of the railway vehicle is a longitudinal speed determined from an angular speed of an axle of the railway vehicle;
said independent longitudinal reference speed v_{ref} being available when said axle is not slipping.

7. The method for estimating a longitudinal acceleration of at least one railway vehicle according to claim 1, wherein said independent longitudinal reference speed v_{ref} of the railway vehicle is a longitudinal speed of the railway vehicle provided by a positioning means;
said independent longitudinal reference speed v_{ref} being available when said positioning means communicates with a satellite.

8. The method for estimating a longitudinal acceleration of at least one railway vehicle according to claim 1, wherein the estimated longitudinal acceleration value aₗₒₙ is determined for a plurality of measurement instants in which said independent longitudinal reference speed v_{ref} of the railway vehicle is available; the plurality of measurement instants being selected according to an acquisition period ΔTi.

9. The method for estimating a longitudinal acceleration of at least one railway vehicle according to claim 1, wherein the estimated longitudinal acceleration aₗₒₙ is continuously determined from an availability instant tₐᵥ coinciding with an instant that directly precedes an unavailability instant in which said independent longitudinal reference speed v_{ref} of the railway vehicle is no longer available, and said first measurement instant tᵢ₁.

10. The method for estimating a longitudinal speed of at least one railway vehicle comprising the steps of:
executing a method for estimating a longitudinal acceleration of at least one railway vehicle according to claim 8;
measuring the value of the independent longitudinal reference speed V_{ref}(tₐᵥ) of said at least one railway vehicle in an availability instant tₐᵥ coinciding with an instant that directly precedes an unavailability instant in which said independent longitudinal reference speed v_{ref} of the railway vehicle is no longer available;
determining the longitudinal speed v_{RV} of the railway vehicle according to the following steps:
calculating the sum of the longitudinal accelerations estimated in the plurality of measurement instants;
multiplying the sum of the longitudinal accelerations determined in the plurality of measurement instants by the acquisition period ΔTᵢ;
adding the value of the independent longitudinal reference speed V_{ref}(tₐᵥ) of said at least one railway vehicle in the availability instant tₐᵥ to the result of the multiplication of the sum of the estimated longitudinal accelerations determined in the plurality of measurement instants by the acquisition period ΔTᵢ.

11. The method for estimating a longitudinal speed of at least one railway vehicle according to claim 10, wherein the step of determining the longitudinal speed v_{RV}(tᵢₙ) of the railway vehicle is carried out by the following formula:
v_{RV}(tᵢₙ)=v_{ref}(tₐᵥ)+Σ₀ⁿaₗₒₙ*ΔTᵢ
where:
v_{ref}(tₐᵥ) is the independent longitudinal reference speed V_{ref}(tₐᵥ) of said at least one railway vehicle in the availability instant tₐᵥ;
Σ₀ⁿaₗₒₙ is the sum of the longitudinal accelerations determined in the plurality of measurement instants tᵢ₁, tᵢ₂, . . . , tᵢₙ and n is the number of acquisition periods elapsed between the availability instant tₐᵥ and the measurement instant of which the longitudinal speed v_{RV}(tᵢₙ) is under determination; and
ΔTᵢ is the acquisition period.

12. The method for estimating a longitudinal speed of at least one railway vehicle comprising the steps of:
executing a method for estimating a longitudinal acceleration of at least one railway vehicle according to claim 9;
measuring the value of the independent longitudinal reference speed of said at least one railway vehicle in the availability instant tₐᵥ;
determining the longitudinal speed of the railway vehicle according to the following steps:
calculating the integral of the estimated longitudinal acceleration aₗₒₙ determined continuously from the availability instant tₐᵥ to said first measurement instant tᵢ₁;
adding the value of the independent longitudinal reference speed of said at least one railway vehicle in the availability instant tₐᵥ to the result of the integral of the estimated longitudinal acceleration.

13. The method for estimating a longitudinal speed of at least one railway vehicle according to claim 12, wherein the step of determining the longitudinal speed of the railway vehicle is carried out by the following formula:
v_{RV}(tᵢ₁)=v_{ref}(tₐᵥ)+∫ₜ_{ₐᵥ}^{t}^{ᵢ₁}aₗₒₙdt
where:
v_{ref}(tₐᵥ) is the independent longitudinal reference speed in the availability instant tₐᵥ;
∫ₜ_{ₐᵥ}^{t}^{ᵢ₁}aₗₒₙ(t)dt is the integral of the estimated longitudinal acceleration aₗₒₙ determined continuously from the availability instant tₐᵥ to the first measurement instant tᵢ₁ of which the longitudinal speed is under determination.

14. The method for estimating a longitudinal speed of at least one railway vehicle according to claim 10, wherein the first measurement instant tᵢ₁ coincides with a return to availability instant t_{ret_av} in which said independent longitudinal references speed V_{ref} becomes available again after being unavailable.
